(19) United States
(12) Patent Application Publication
(10) Pub. No.: US 2002/0013692 A1
(43) Pub. Date: Jan. 31, 2002

(54) Method of and system for screening electronic mail items

(76) Inventors: Ravinder Chandhok, Wanesburg, PA (US); Dale Wiggins, Pittsburgh, PA (US); David Kaufer, Pittsburgh, PA (US); Geoffrey Wenger, Pittsburgh, PA (US)

Correspondence Address: QUALCOMM Incorporated, Attn: Patent Department, 5775 Morehouse Drive, San Diego, CA, 92121-1714, US

(21) Appl. No.: 09/907,151

(22) Filed: Jul. 16, 2001

Related U.S. Application Data
(60) Provisional application No. 60/218,580, filed on Jul. 17, 2000.

(51) Int. Cl. G06F 17/20

(52) U.S. Cl. 704/1; 707/532

(57) ABSTRACT

An electronic mail system identifies e-mail that conforms to a language type. A scoring engine compares electronic text to a language model. A user interface assigns a language indicator to an e-mail item based upon a score provided by the scoring engine.

### CROSS-REFERENCE TO RELATED APPLICATION

The present application claims the benefit of U.S. Provisional Application Ser. No. 60/218,580, filed Jul. 17, 2000, and titled “Method of and System for Screening of Electronic Mail Items.”

### FIELD OF THE INVENTION

The present invention relates generally to the field of electronic mail (e-mail) software and systems, and more particularly to a method of and system for screening or classifying e-mail items and other electronic files based upon content.

### BACKGROUND OF THE INVENTION

Electronic mail (e-mail) has become a ubiquitous form of communication in recent years. In general, e-mail works as follows. E-mail software is installed on a client device, e.g. a personal computer (PC), equipped or configured for communication with a plurality of other client devices via a communications network. Software embodied in the e-mail client enables a user of the client device to compose e-mail messages, send e-mail messages to other client devices via the communications network, and read e-mail messages received from other client devices via the communications network. The typical e-mail client supports one or more e-mail protocols such as Post Office Protocol Version 3 (POP3), Simple Mail Transfer Protocol (SMTP), Internet Mail Access Protocol Version 4 (IMAP4), or Multipurpose Internet Mail Extensions (MIME).

E-mail has become a predominant form of communication, both within organizations and among individuals. In many business organizations, each member of the organization has a computer with a network connection on his or her desk. Additionally, many individuals have access to e-mail through private Internet service provider accounts. Accordingly, many people have access to e-mail, by which they may write, send, receive, reply to, and forward e-mail messages quickly and easily.

One of the consequences of the proliferation of e-mail is the phenomenon of flaming. Flaming may be defined as computer-mediated communication designed to intimidate by withholding the expected courtesies of polite communication. Sometimes the withholding of respect takes the form of direct aggressiveness against the receiver. Often, flaming takes the form of gross insensitivity and bad taste, not only against the receiver but also against the culture at large. The expression of hate, for its own sake, seems to have a frightening and intimidating effect on human beings. Flamers seem capable of intimidating solely by expressing their hatreds, even if the receiver, who does not share the hate, is not the personal target.

Because of its intimidating nature, most people do not like to receive flaming e-email, and they are usually shocked when they read a piece of flaming e-mail. Additionally, while people frequently need to express themselves forcefully, all but the most mean-spirited would prefer not to send e-mail that may be perceived as excessively flaming.

### SUMMARY OF THE INVENTION

The present invention provides an electronic mail system user interface that identifies flaming e-mail. The system of the present invention includes a scoring engine that compares electronic text to flaming language models. In the preferred embodiment, the flaming language models are contained in dictionaries of words and phrases.

In one embodiment of the present invention, the scoring engine is used to process incoming e-mail items. When the system of the present invention receives a message, the scoring engine processes the received message and returns a score. The score signifies the level of flaming content in the message. The system of the present invention assigns a graphical representation to the message based upon the score returned from the scoring engine. The system of the present invention lists the message in the user's mailbox with the graphical representation. The user can see in the mailbox that the message has a particular flaming content, thereby enabling the user to decide whether or not to open the message or perform other actions with respect to the message. The system of the present invention may include a filtering mechanism by which the message may be processed automatically without user interaction.

In another of its aspects, the present invention provides a tool for use during composition of messages. During composition processing, the system of the present invention waits for text input. Periodically, the system performs scoring engine processing on input text. The system assigns a graphical representation to the message based upon the score returned from the scoring engine and displays a control, preferably in association with a send button in the e-mail application window toolbar, with the graphical representation indicating the offensive content of the text. The graphical representation enables the user to determine the flaming content of the composition. The system of the present invention may highlight the offensive words or phrases in the text.

The system of the present invention may prompt the user to reconsider sending offensive messages. Also, the system of the present invention may queue offensive messages rather than send such messages immediately, thereby giving the user a chance to reconsider and edit the message before it is actually sent.

### BRIEF DESCRIPTION OF THE DRAWINGS

FIG. 1 is a high-level block diagram of an e-mail system according to the present invention.

FIG. 2 is a high-level flow chart of composition processing according to the present invention.

FIG. 3 is a high-level flow chart of mailbox processing according to the present invention.

FIGS. 4A and 4B are high-level flow charts of scoring engine processing according to the present invention.

FIG. 5 is a pictorial representation of an email text composition window according to the present invention.

FIG. 6 is a pictorial representation of a tools drop down menu according to the present invention.

FIG. 7 is a pictorial representation of an email screening options dialog according to the present invention.

FIG. 8 is a pictorial representation of an email send warning dialog according to the present invention.

FIG. 9 is a pictorial representation of a mailbox window according to the present invention.

### DESCRIPTION OF THE PREFERRED EMBODIMENT

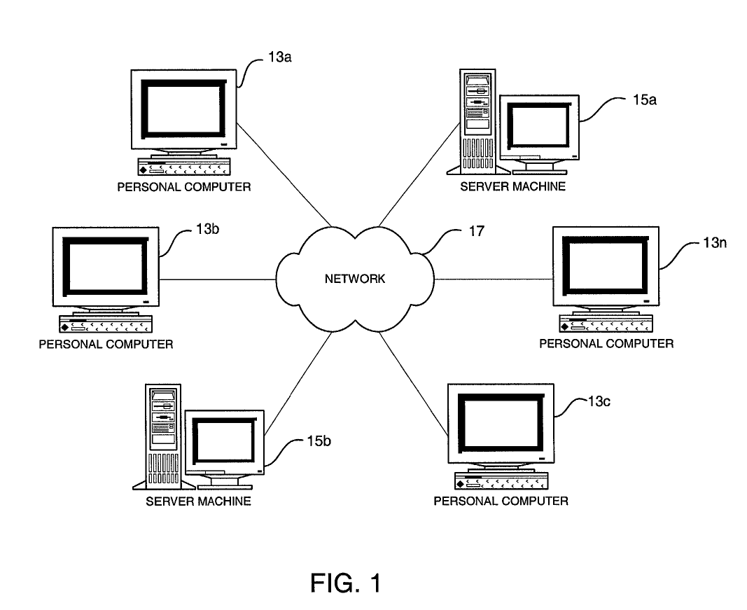

Referring now to the drawings, and first to FIG. 1, an electronic mail (email) system is designated generally by the numeral 11. System 11 includes a plurality of client machines 13, which are preferably implemented in personal computers, and at least one server machine 15. Personal computer client machines 13 have installed thereon client software according to the present invention that operates preferably in a graphical operating environment, such as Windows 98. Client machines 13 and server machines 15 are interfaced to a network indicated generally at 17. Network 17 may be a local area network, a wide area network, the Internet, or a combination of such networks. Client machines 13 and server machines 15 may be interfaced to network 17 through network interface cards, Internet service providers, or the like, as is well known to those skilled in the art.

The present invention provides a method of and system for identifying flaming e-mail content. The system of the present invention includes a flaming language model that is implemented in a set of language dictionaries. A regular dictionary contains less offensive words or phrases that are scored according to frequency. Typically, a single occurrence of such a word or phrase will not be sufficient to score the message as flaming. In order to be scored as a flame, words or phrases matching words or phrases in the regular dictionary will have to appear as a certain percentage of the entire text. Thus, the longer the text, the more occurrences of flaming matches will be needed in order to score the message as flaming. For very short or long texts, the frequencies of flaming matches may be skewed very high or very low. Accordingly, the present system of the invention may maintain both absolute count thresholds as well as frequency thresholds for the regular dictionary words and phrases. The regular dictionary may include, for example, mild epithets and vulgarities, phrases that would tend to insult or put a person of normal sensitivities on the defensive, and the like.

The other dictionary maintained according to the present invention is a high dictionary. The high dictionary contains words or phrases that are so shocking, threatening, insulting, vulgar, obscene, or otherwise offensive as to make the message flaming based on a single occurrence of such word or phrase, unless the message is very long.

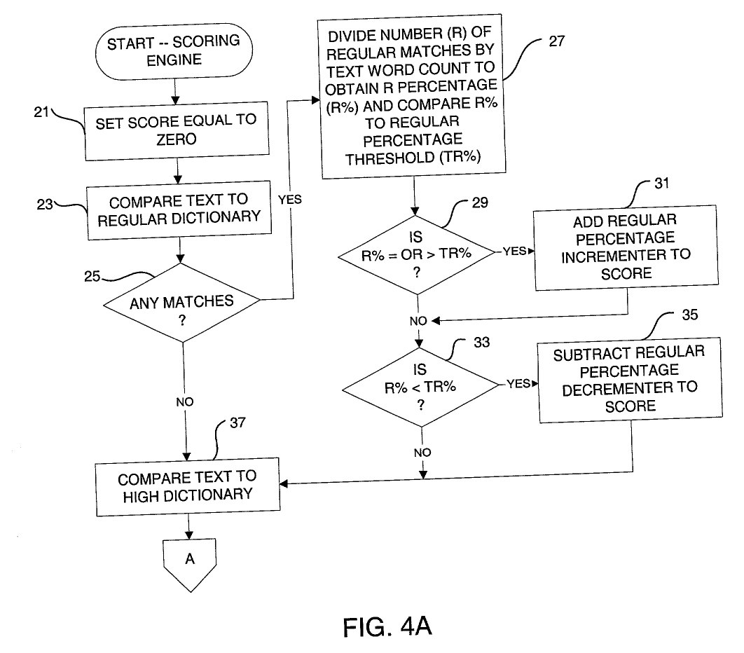

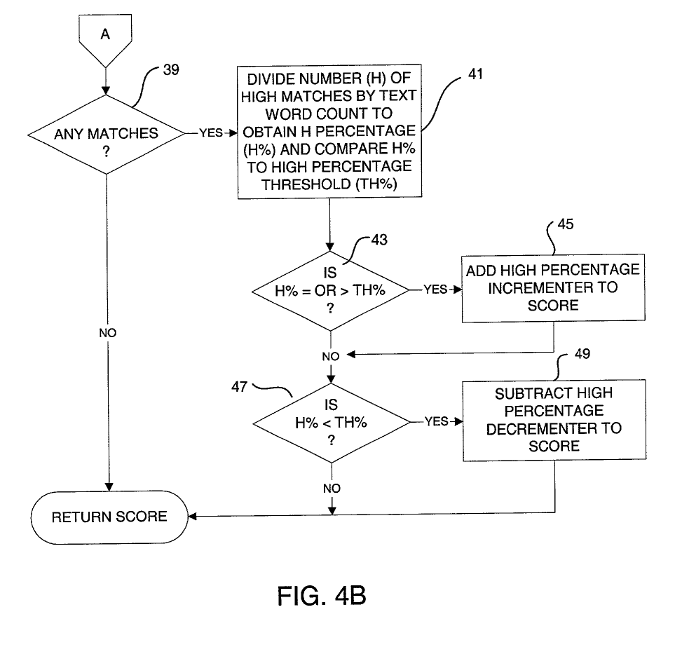

Referring first to FIG. 4A, there is shown a high-level flow chart of scoring engine processing according to the present invention. Initially, the score is set equal to zero at block 21. Then, the text is compared to the regular dictionary at block 23. If, as determined at decision block 25, there are any matches of words or phrases in the text to words or phrases in the regular dictionary, the system divides the number R of regular dictionary matches by the number of words in the text to determine the frequency of regular dictionary matches as a percentage R % of the entire text, at block 27. The system then tests, at decision block 29, if the percentage R % of regular dictionary matches is equal to or greater than a regular percentage threshold TR %. If so, the system adds a regular percentage incrementer to the score, at block 31. If, as determined at decision block 33, the percentage R % of regular dictionary matches is less than a regular percentage threshold TR %, the system subtracts a regular percentage decrementer from the score, as indicated at block 35.

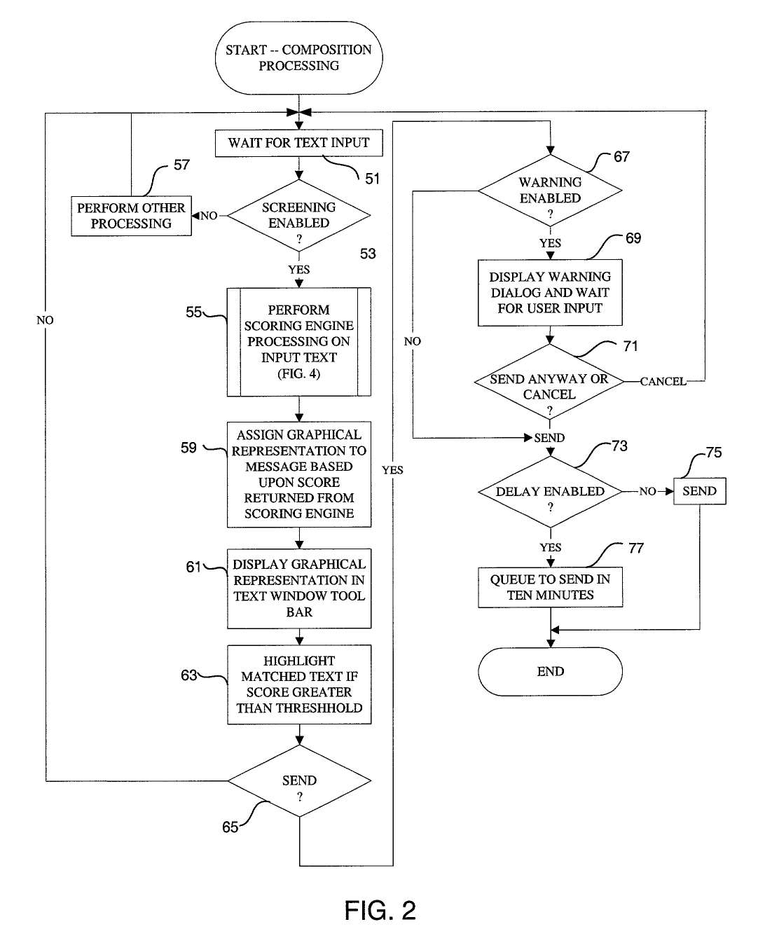

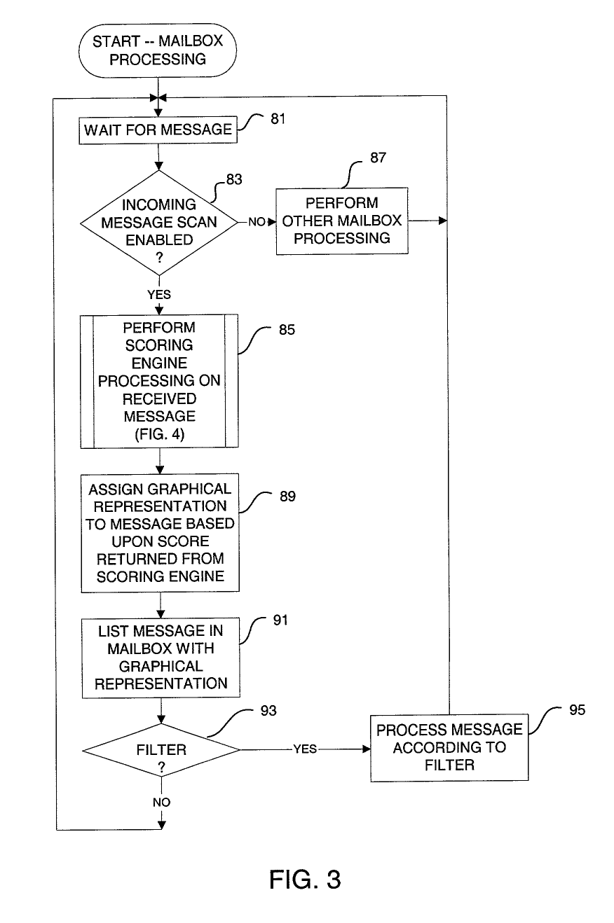

After regular dictionary processing, the scoring engine compares the text to the high dictionary, at block 37. Referring to FIG. 4B, if, as determined at decision block 39, there are any matches of words or phrases in the text to words or phrases in the high dictionary, the system divides the number H of high dictionary matches by the number of words in the text to determine the frequency of high dictionary matches as a percentage H % of the entire text, at block 41. The system then tests, at decision block 43, if the percentage H % of high dictionary matches is equal to or greater than a high percentage threshold TH %. If so, the system adds a high percentage incrementer to the score, at block 45. If, as determined at decision block 47, the percentage H % of high dictionary matches is less than a high percentage threshold TH %, the system subtracts a high percentage decrementer from the score, as indicated at block 49. After the system has completed scoring engine processing according to FIGS. 4A and 4B, the system returns the score to text composition processing or mailbox processing, as described with respect to FIGS. 2 and 3, respectively.

Referring now to FIG. 2, there is shown a high-level flow chart of text composition processing according to the present invention. While in the preferred embodiment, the present invention is part of an electronic mail system, those skilled in the art, will recognize that the scoring engine of the present invention may be used to identify flaming or other linguistic content in other electronic text files. The system of the present invention waits for text input at block 51. If, as determined at decision block 53, screening is enabled, the system periodically performs scoring engine processing on the input text, as indicated generally at block 55 and discussed in detail with respect to FIGS. 4A and 4B. If screening is not enabled, the system performs other processing, as indicated generally at block 57.

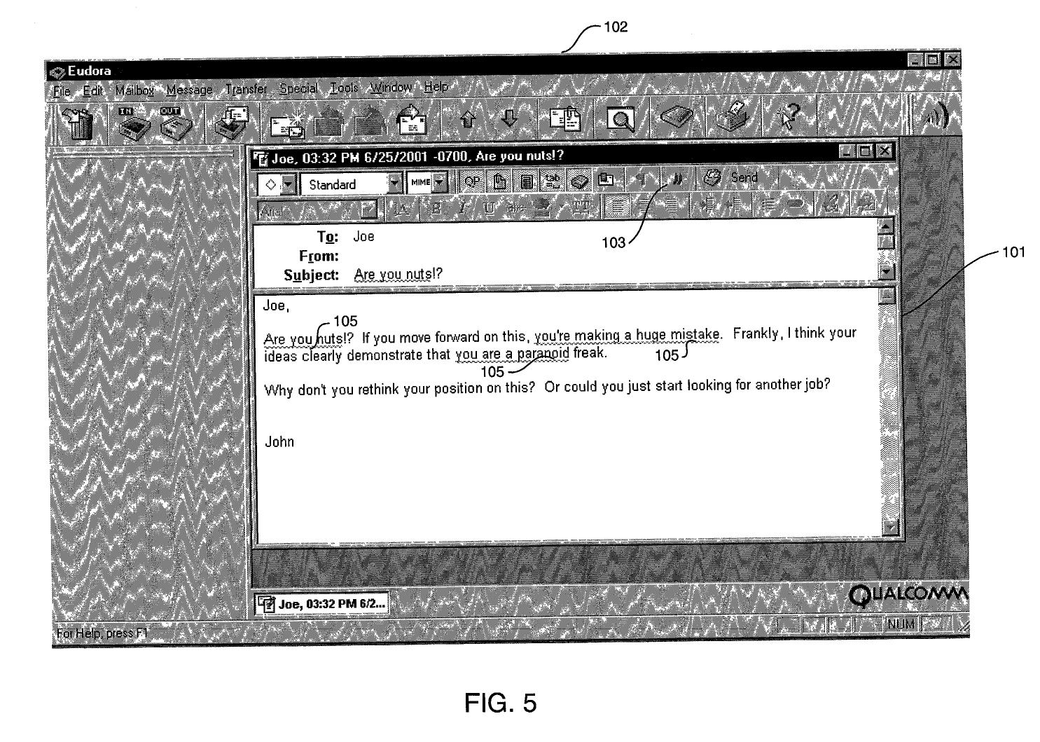

The system assigns a graphical representation to the text based upon the score returned from the scoring engine, at block 59. In the preferred embodiment, and as shown with respect to FIGS. 5-9, flaming content is indicated graphically by chili peppers. Low, medium, or high flaming content is indicated by one, two or three chili papers, respectively. Flaming content less than a predefined threshold value may be indicated either by the absence of an indicator or by a particular graphical representation, such as an ice cube.

The system displays a control with the graphical representation in the text window toolbar, preferably in association with a send button, at block 61. The system may also highlight the matching text if the score returned from the scoring engine is greater than the threshold value, as indicated at block 63. The highlighting may differentiate between high dictionary matches and low dictionary matches. For example, low dictionary matches may be underlined with a wavy green line and high dictionary matches may be underlined with a wavy combination red and green line.

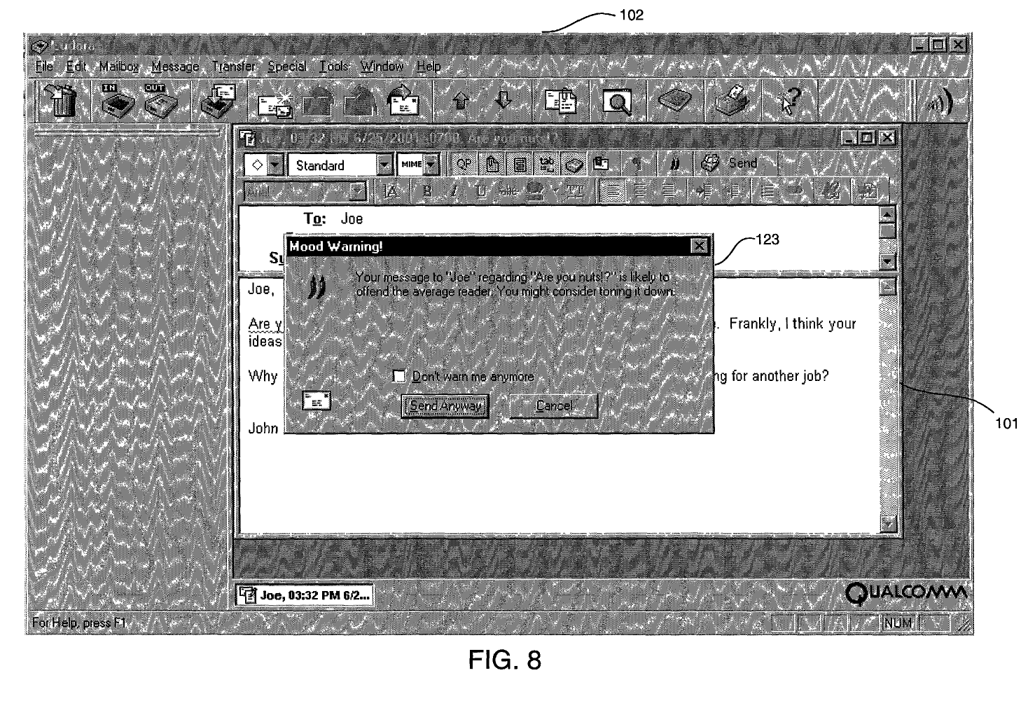

FIG. 2 processing continues until the user closes the text window or selects a send button, as indicated at decision block 65. If the user selects the send button, the system tests, at decision block 67, if a warning feature is enabled. If so, as indicated at block 69 and as will be discussed in more detail with respect to FIG. 8, the system displays a dialog box warning the user that the message contains offensive or potentially offensive content and waits for user input. The warning dialog presents the user with a choice of canceling the send command or sending the message anyway. If, at decision block 71, user elects to cancel the send, processing returns to block 51. If the user elects to send the message anyway, the system tests, at decision block 73, if a delay feature is enabled. If not, the system places the message in a queue to be sent substantially immediately, as indicated at block 75. If the delay feature is enabled, the system places the message in a queue to be sent at a predefined later time, for example in ten minutes, as indicated at block 77.

Referring now to FIG. 3, there is shown a high-level flow chart of mailbox processing according to the present invention. The system waits for a message at block 81. If, as determined at decision block 83, incoming message scanning is enabled, the system performs scoring engine processing on the received message, as indicated generally at block 85 and described in detail with respect to FIGS. 4A and 4B. If scanning is not enabled, the system performs other mailbox processing, as indicated generally at block 87.

When a score is received from the scoring engine, the system assigns a graphical representation to the message based up on the score returned from the scoring engine, at block 89. Again, the graphical representation may be represented with chili peppers. Then, the system lists the message in the mailbox with the graphical representation, at block 91. Then, the system tests, at decision block 93, if a filter is set with respect to the message. If so, the system processes the message according to the filter, at block 95, and processing returns to block 81. Examples of filtering include automatically deleting messages with a selected flaming level or forwarding the message to the sender's manager. If no filters are set, then and processing returns to block 81.

Referring now to FIG. 5, a text input window according to the present invention is indicated generally by the numeral 101. Window 101 is displayed within an electronic mail application window 102 and it depicts an e-mail message from a sender to a recipient. The system of the present invention has scored the text of the message as moderately flaming, as indicated by an icon 103. The offensive text is highlighted by underlining 105. The underlining allows the user to see the basis for the determination that the message as a whole is or may be offensive. Thus, the user can edit the message to make it less offensive.

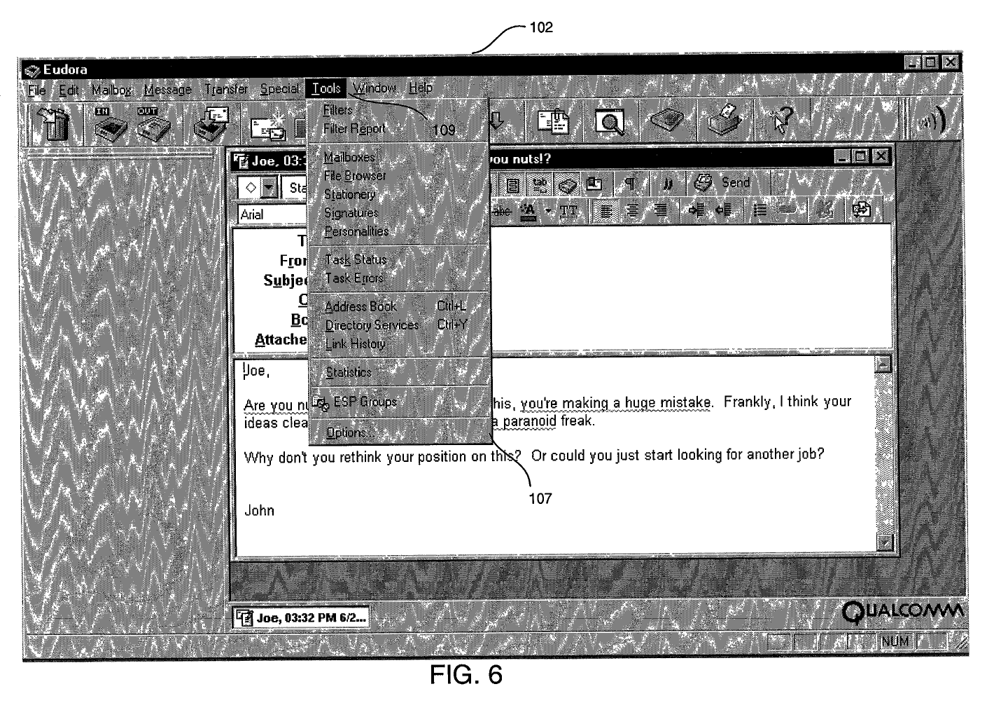

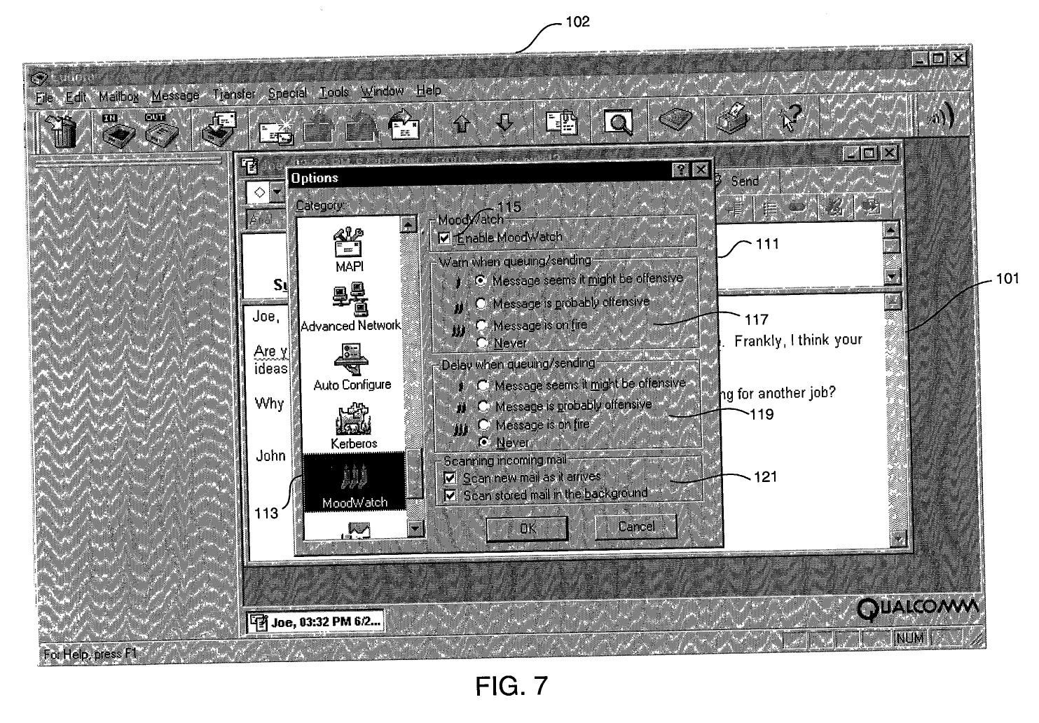

As illustrated with respect to FIGS. 6 and 7, screening features according to the present invention may be set and enabled by selecting an options choice 107 from a drop down list under tools choice 109 in application window 102. Selection of options 107 causes the system to display an options dialog 111, as shown in FIG. 7. The screening function of the present invention is referred to in the illustrated examples as MoodWatch. Selection of a MoodWatch icon 113 presents the user with choices of enabling the screening, warning, send delaying, and mailbox scanning functions of the present invention. As shown in FIG. 7, a check box 115 is provided for enabling screening according to the present invention. A set 117 of radio button controls is provided for configuring the warning feature according to the present invention. As shown in FIG. 7, the warning feature may be configured to warn based upon the level of offensiveness. Similarly, a set 119 of radio button controls is provided to enable the user to configure the delay when sending or queuing feature of the present invention. Finally, a set 121 of check boxes is provided to enable the user to enable the mailbox scanning features of the present invention.

Referring now to FIG. 8, there is illustrated a warning dialog box 123 according to the present invention. As described with respect to FIG. 7 warning dialog box 123 is enabled and configured with options dialog box 111. As described with respect to FIG. 2, warning dialog box, when enabled, is displayed when the user attempts to send an offensive or potentially offensive message. Dialog box 123 provides the user with the choice of either canceling the send command or sending the message anyway. Dialog box 123 also includes a check box to enable the user to disable the warning function.

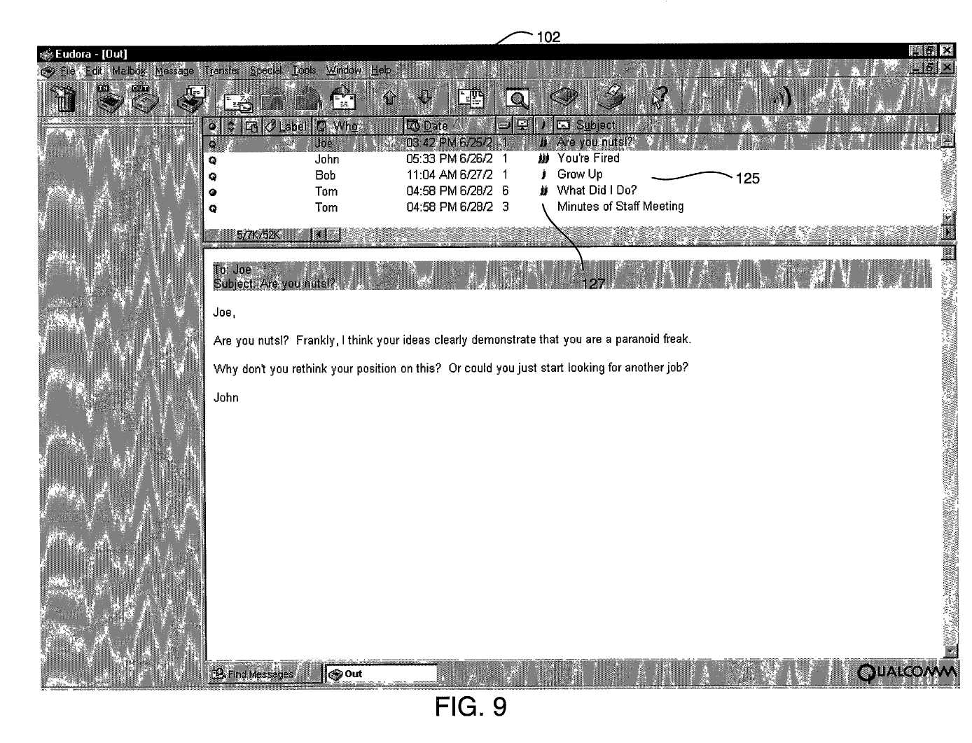

Referring now to FIG. 9, an electronic mailbox window is designated generally by the numeral 125. Mailbox window 125 includes a list of e-mail items contained in the user's electronic mailbox. According to the present invention, mailbox window 125 includes a column 127 that provides, for each item in the mailbox, information with respect to the flaming content of the item.

From the forgoing, it may be seen that the present invention provides a method and system for identifying and enabling a user to deal with flaming content. It should be apparent to those skilled in the art that the invention is applicable to identifying other linguistic content. For example other linguistic content, such as affection, Spam, condescending tone and the like may be modeled and identified according to the present invention. In addition to use within an electronic mail system, the method and system of the present invention find application in connection with the processing of other electronic text files, such as in word processing applications and the like.

What is claimed is:

1. A method of monitoring language content of text information, which comprises:
comparing text to a language model, said language model including words and phrases of a particular language type; and,
assigning to said text a language indicator based upon results of comparing said text to said language model.

2. The method as claimed in claim 1, wherein said language type is offensive language.

3. The method as claimed in claim 1, wherein said language type is intimidating language.

4. The method as claimed in claim 1, including:
highlighting material of said text that matches words or phrases of said language model.

5. The method as claimed in claim 1, wherein said language indicator comprises a graphical symbol.

6. The method as claimed in claim 1, wherein said results includes a numerical score.

7. The method as claimed in claim 6, wherein said language indicator is related to said numerical score.

8. A method of monitoring language content of electronic mail, which comprises:
comparing text of an electronic mail item to a language model, said language model including words and phrases of a particular language type; and,
assigning to said electronic mail item a language indicator based upon results of comparing said text to said language model.

9. The method as claimed in claim 8, wherein said language type is offensive language.

10. The method as claimed in claim 8, wherein said language type is intimidating language.

11. The method as claimed in claim 8, including:
highlighting material of said text that matches words or phrases of said language model.

12. The method as claimed in claim 8, wherein said language indicator comprises a graphical symbol.

13. The method as claimed in claim 8, wherein said results includes a numerical score.

14. The method as claimed in claim 13, wherein said language indicator is related to said numerical score.

15. The method as claimed in claim 13, including highlighting material of said text that matches words or phrases of said language model when said numerical score is greater than a particular value.

16. The method as claimed claim 8, including:
prompting a user to reconsider sending said electronic mail item based upon said results.

17. The method as claimed in claim 8, including:
delaying sending said electronic mail item based upon said results.

18. The method as claimed in claim 8, wherein said electronic mail item is stored in an electronic mailbox and language indicator is displayed in association with an index to said item in said mailbox.

19. The method as claimed in claim 8, wherein said electronic mail item is a received item and said method includes:
filtering said mail item based upon said results.

20. A electronic mail system, which comprises:
a scoring engine configured to assign a score to an electronic mail item based upon a comparison of text of said mail item with a language model, said language model including words and phrases of a particular language type; and,
a user interface configured to associate a language indicator to said mail item based upon said score.

21. The system as claimed in claim 20, wherein said language type includes offensive language.

22. The system as claimed in claim 20, wherein said language type includes intimidating language.

23. The system as claimed in claim 20, wherein said user interface is configured to highlight material of said text that matches words or phrases of said language model.

24. The system as claimed in claim 20, wherein said language indicator comprises a graphical symbol.

25. The system as claimed claim 20, wherein said user interface is configured to prompt a user to reconsider sending said electronic mail item based upon said score.

26. The system as claimed in claim 20, wherein said electronic mail system is configured to delay sending said electronic mail item based upon said score.

27. The system as claimed in claim 20, wherein said electronic mail item is stored in an electronic mailbox and said user interface is configured to display said language indicator in association with an index to said item in said mailbox.

28. The system as claimed in claim 20, including:
a filter configured to process said mail item based upon said score.
